(19) United States
(12) Patent Application Publication
(10) Pub. No.: US 2026/0300933 A1
(43) Pub. Date: Oct. 1, 2026

(54) INTELLIGENT ROAD PLANNING MANAGEMENT

(71) Applicant: SAP SE, Walldorf (DE)

(72) Inventors: Priyanka Aggarwal, Rohini (IN); Srinivasan Ramanathan, Bangalore (IN); Gokul Gowri Shankar Krishnan, Bangalore (IN); Athira M D, Bangalore (IN)

(21) Appl. No.: 19/090,620

(22) Filed: Mar. 26, 2025

(51) Int. Cl. G06Q 10/20; G06Q 10/0637; G06Q 50/26

(52) U.S. Cl. CPC G06Q 10/20; G06Q 10/0637; G06Q 50/26

(57) ABSTRACT

The described examples focus on a technology designed to improve road maintenance planning. This technology addresses the challenges faced in maintaining road infrastructure effectively. Traditional methods for selecting these treatments often rely on subjective assessments and historical data. These methods can lead to inefficient resource allocation and increased maintenance costs. The described examples propose a data-driven, optimization-based approach to road maintenance planning.

### TECHNICAL FIELD

This document generally relates to road maintenance. More specifically, this document relates to an intelligent road planning management system.

### BACKGROUND

Effective road maintenance plays a crucial role in ensuring the longevity and performance of road infrastructure.

### BRIEF DESCRIPTION OF THE DRAWINGS

The present disclosure is illustrated by way of example and not limitation in the figures of the accompanying drawings, in which like references indicate similar elements.

FIG. 1 is a block diagram illustrating a road treatment optimization system, in accordance with an example embodiment.

FIG. 2 is an example of optimizations performed on a sample dataset, in accordance with an example embodiment.

FIG. 3 is a flow diagram illustrating a method of performing road maintenance, in accordance with an example embodiment.

FIG. 4 is a block diagram illustrating an architecture of software, which can be installed on any one or more of the devices described above.

FIG. 5 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

To manage road maintenance effectively and efficiently, roads are divided into smaller units called road segments of some predetermined length (e.g., 100 meters). The maintenance performed on a segment is known as a treatment. Over a span of years—often up to 30—a treatment plan is designed. This plan outlines a sequence of physical treatments to road maintenance for each segment, balancing long-term care with practical constraints.

The described examples focus on a technology designed to improve road maintenance planning. This technology addresses the challenges faced in maintaining road infrastructure effectively. Traditional methods for selecting these treatments often rely on subjective assessments and historical data. These methods can lead to inefficient resource allocation and increased maintenance costs. The described examples propose a data-driven, optimization-based approach to road maintenance planning.

The technology uses a systematic framework to select road treatment plans. It employs Integer Programming to evaluate different treatment options for each road segment. This approach considers various constraints and user-defined objectives. The goal is to optimize decisions based on factors like treatment costs, road condition data, and budgetary constraints. The technology integrates these elements into a structured optimization framework.

Integer programming is an optimization technique where the solution space is restricted to integer values. It involves finding the optimal solution to a problem defined by a set of linear equations and inequalities, where some or all of the decision variables are required to be integers.

In an example embodiment, a systematic evaluation of multiple treatment alternatives, optimizing decisions based on various constraints and user-defined objectives. The method employs a linear programming model that integrates key considerations, including:
Objective Functions: Maximizing Benefit
Treatment Costs: Accounting for material, labor, vehicle, and equipment costs associated with each treatment option.
Road Condition Data: Leveraging metrics like pavement condition, surface distress, and other relevant indicators.
Budgetary Constraints: Ensuring adherence to predefined yearly budget limitations.
Time Constraints: Factoring in the allowable time frames for implementation.
Additional Constraints: Enabling flexible options, such as cumulative budget allocations for enhanced user control.

By integrating these elements into a structured optimization framework, the invention ensures the efficient allocation of resources and enables cost-effective and practical road maintenance planning.

The model considers benefit as a required objective. It includes budget constraints, while also factoring in long-term goals and environmental impact. This ensures that the chosen plans not only work within the given budgets but also provide the best possible outcomes for road performance and sustainability.

The process begins with data gathering and preparation. This includes collecting information on road conditions and costs. A computer model is then used to define the problem, considering both objectives and constraints. An optimization algorithm runs this model to find the best set of treatments for each segment. The technology ensures that the chosen plans work within given budgets and provide favorable outcomes for road performance.

The provided framework provides the following features:
Objective Selection: Maximizing the benefits
Total Budget Constraints: The optimization model takes into account the total budgets allocated for each treatment plan across all road segments over a period of planning years, ensuring that costs remain within the defined financial limits.
Yearly Budget Constraints: The optimization model takes into account the yearly budgets allocated for each treatment plan across all road segments, ensuring that costs remain within the defined financial limits.
Individual Yearly Cost Category Budget Constraints: The optimization model takes into account the yearly budgets allocated for each type of cost category for each treatment plan across all road segments, ensuring that costs remain within the defined financial limits
Variables and Decision Making: The variables in the model are represented as xij, where “i” is the road segment and “j” is the treatment option. The values of xij are binary (either 0 or 1), indicating whether a particular treatment is applied to a given road segment.
Unique Treatment Assignment: For each road segment, the model ensures that only one treatment plan is selected by enforcing the constraint that only one xij is equal to 1 for every road segment “i”. This guarantees that each segment receives exactly one treatment, simplifying decision-making and ensuring a well-defined maintenance strategy.

This combination of customizable objectives, clear decision variables, and adherence to budget constraints creates an efficient, flexible framework for optimizing road treatment plans.

There are a number of outlined constraints and optimization goals that shape the road treatment planning process:

### Constraints:

### Budget Constraints:

The model includes yearly budget constraints, total budget constraints, or Individual Yearly Cost Category Constraints
   Yearly Budget Constraints ensure that the cost of treatment plans for each road segment does not exceed the allocated budget for each year. This helps maintain financial control and ensures that the treatment plans are spread out effectively across the project timeline.
   Total Budget Constraints consider the cumulative budget for all years, ensuring that the total cost of all treatments over the entire planning period does not exceed the predefined total budget. This constraint ensures that the overall financial resources allocated for the project are respected.
   Individual Yearly Cost Category Budget Constraints ensure that each category cost of treatment plans for each road segment does not exceed the allocated budget for each year. This helps maintain financial control and ensures that the treatment plans are spread out effectively across the project timeline.

### Unique Treatment Assignment:

For each road segment, only one treatment option can be selected. This constraint ensures that each road segment is assigned exactly one treatment from the available options, preventing duplication of treatments for the same segment.

### Optimization Goals:

### Maximizing Road Performance:

The model aims to maximize the benefit of the road segments by optimizing for key metrics. This ensures that the road treatment plans selected will achieve the best possible condition and operational efficiency within the given constraints.

The benefit can be assessed using various metrics, such as the Pavement Condition Index (PCI) and Vehicle Operating Cost (VOC). These indicators measure the condition of a road by considering factors like cracks, bumps, potholes, roughness, and overall surface quality.

Maximizing benefit can be understood as minimizing the issues of the road like minimizing roughness, cracking, or PCI, VOC etc.

The framework begins by preprocessing data. The data preprocessing phase is useful to prepare the dataset for optimization by consolidating the information into a more manageable and meaningful form. The dataset initially provides yearly costs for each treatment plan, but for the optimization model, the total cost for each treatment plan across all years is needed. This necessitates aggregating the yearly data into a single value that reflects the cumulative cost and an averaged road condition over the span of years.

The following preprocessing steps are applied:

### 1. Aggregating Yearly Costs:

1. Since the dataset includes yearly costs for each treatment plan, the total cost for each treatment is calculated by summing the costs across all years. This gives a single value that represents the total cost of applying a particular treatment plan to a road segment over the entire planning period.
   2. The dataset also includes yearly costs for each cost category for a treatment plan. The total cost for each cost category for a treatment is calculated by summing the cost for each cost category across all years. This gives a single value for each category that represents the total category cost of applying a particular treatment plan to a road segment over the entire planning period

### 2. Averaging Road Condition Metrics:

Road condition Key Performance Indices (KPIs) (such as PCI, VOC etc.), which may vary across years, can be calculated in different ways, such as:
   1. compute the average value of these metrics over the span of years for each treatment plan.
   2. compute the area under the curve of these metrics over the span of years for each treatment plan.
   3. compute the summed value of these metrics over the span of years for each treatment plan.
   4. compute the weighted average value of these metrics over the span of years for each treatment plan.
This ensures that the road condition for each treatment is represented by a single aggregated value, simplifying the model while preserving important performance data.

### 3. Excluding Yearly Diversification:

Once the total cost and average road condition metrics are calculated, the individual yearly data is eliminated to focus on the aggregated values. Each treatment plan record will now contain a single row that represents the overall cost and the aggregated road condition, removing the need to differentiate by year.

As a result, the preprocessed dataset contains one record for each treatment plan, with the total cost(s) and aggregated road conditions over the entire period, making it ready for optimization. This simplified dataset is now structured to facilitate efficient decision-making without the complexity introduced by yearly diversifications.

TABLE 1
describes variables utilized in the model as follows:

| Variables | Definition | Range |
|---|---|---|
| N | Total number of available | — |
| | road segments. | |
| M | Total number of years. | — |
| p | Number of cost categories | — |
| nᵢ | Number of Treatment Plans | 1 ≤ i ≤ N |
| | for the ith Road Segment. | |
| Bₖ | Budget Value provided by the | 1 ≤ k ≤ m |
| | user for the kth year. | |
| yₖ | kth year which ranges from the | 1 ≤ k ≤ m |
| | first year to total number of years. | |
| xᵢⱼ | Decision Variables | 1 ≤ j ≤ nᵢ |
| | | 1 ≤ i ≤ N |
| Rᵢ | ith Road segment | 1 ≤ i ≤ N |
| Tᵢⱼ | Treatment plan for the ith | 1 ≤ j ≤ nᵢ |
| | road segment | 1 ≤ i ≤ N |
| | and jth Treatment Plan | |
| Cᵢⱼₖ | Yearly Treatment costs | 1 ≤ k ≤ m, |
| | | 1 ≤ j ≤ nᵢ |
| | | 1 ≤ i ≤ N |
| Cᵢⱼₖₗ | Yearly Treatment costs for | 1 ≤ l ≤ p |
| | Cost Category 1 | 1 ≤ k ≤ m, |
| | | 1 ≤ j ≤ nᵢ |
| | | 1 ≤ i ≤ N |
| PCIᵢⱼₖ | PCI Yearly values | 1 ≤ k ≤ m, |
| | | 1 ≤ j ≤ nᵢ |
| | | 1 ≤ i ≤ N |
| APᵢⱼ | Average PCI Values | 1 ≤ j ≤ nᵢ |
| | | 1 ≤ i ≤ N |
| TPᵢⱼ | Total PCI Value | 1 ≤ j ≤ nᵢ |
| | | 1 ≤ i ≤ N |
| AUCᵢⱼ | Area Under the Curve-PCI | 1 ≤ j ≤ nᵢ |
| | | 1 ≤ i ≤ N |

Furthermore,

$${x}_{ij} for i \leq 1 \leq n ; 1 \leq j \leq {n}_{i}$$

is a binary variable defined as

$${x}_{ij} = \{ \begin{matrix}1 , & if Treatment Plan j is selected for Road segment i \\ 0 , & otherwise\end{matrix}$$

In an example embodiment, the model supports multipole objectives that can be selected based on user requirements. These include maximizing benefit, such as the following:

$$max {\sum }_{i}^{n} {\sum }_{j = 1}^{{n}_{i}} {x}_{ij} * {Benefit}_{ij}$$

For constraints, in an example embodiment, one constraint is that there can be only one treatment selected for each road segments, or:

$${\sum }_{j = 1}^{{n}_{i}} {x}_{ij} = 1 ∀ i$$

Further, two variants of budget constraints are supported, one being the total budget constraint for all years aggregated, and the other being the yearly budget for years within [y1, y2].

The total budget constraint is:

$${\sum }_{j = 1}^{{n}_{i}} {x}_{ij} = 1 ∀ i \\ Number of constraints = 1$$

The yearly budget constraints are:

$${\sum }_{i = 1}^{n} {\sum }_{j = 1}^{{n}_{i}} {x}_{ij} * {C}_{ijk} \leq {Budget}_{k} , y 1 \leq k \leq y 2 \\ Number of constraints = y 2 - y 1 + 1$$

The yearly cost category budget constraints are:

$${\sum }_{i = 1}^{n} {\sum }_{j = 1}^{{n}_{i}} {x}_{ij} * {C}_{ijkl} \leq {Budget}_{k l} , y 1 \leq k \leq y 2 , 1 \leq l \leq p , \\ Number of constraints = p * ( y 2 - y 1 + 1 )$$

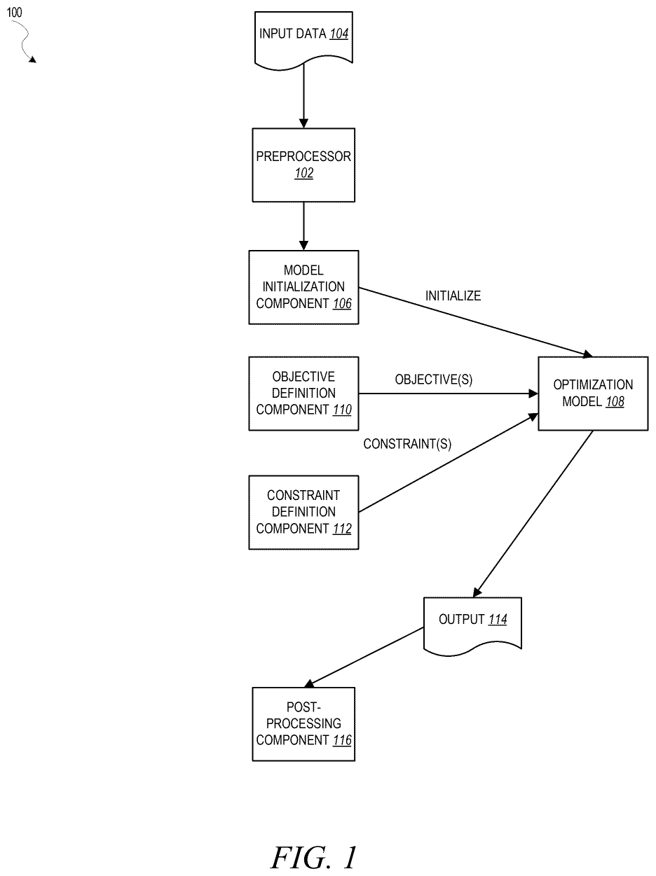

FIG. 1 is a block diagram illustrating a road treatment optimization system 100, in accordance with an example embodiment. A preprocessor 102 takes input data 104, including, for example, road details, treatment plan details (plan, identification, yearly costs), KPI details (PCI, VOC values) and budget values (yearly, aggregated, or cost category-wise) and preprocesses it to create a simplified representation of road segments and treatment plans, and to ensure that all necessary benefits and constraints are included. At the software level, the preprocessor 102 may implement code to load the input data 104 and code to preprocess the loaded input data 104. In one example embodiment, the code to load the input data 104 may define a function load_data(filepath) that reads a large CSV file in chunks using pandas.read_csv( ).
chunksize=10**6 helps when dealing with large CSV files that may not fit entirely in memory, as it processes the file in smaller pieces to avoid memory overload.
By specifying the dtype for each column, the code reduce memory usage (especially for columns that have repetitive values, like ROADSEGMENTID and TREATMENTPLANID), which makes the process more efficient.

The load code may be as follows:

```
def load_data(filepath):
  chunksize = 10**6 # Adjust based on available memory
  chunks = pd.read_csv(filepath, chunksize=chunksize,
dtype={
    ‘ROADSEGMENTID’: ‘category’,
    ‘TREATMENTPLANID’: ‘category’,
    ‘YEAR’: ‘int32’,
    ‘totalyearlycost’: ‘float32’,
    ‘avg pci: ‘float32’
  })
  return pd.concat(chunks, ignore_index=True)
```

Additionally, in one example embodiment, the code to preprocess the input data 104 may be a function build_lookups(chunk), which is used to create two lookup structures, one for costs(cost_lookup) and one for average PCI values(pci_lookup) for a specific chunk of data.

The preprocess code may be as follows:

```
def build_lookups(chunk):
  # Build cost and PCI lookups for a chunk of data
  cost_lookup = defaultdict(dict)
  pci_lookup = { }
  for _, row in chunk.iterrows( ):
    road_id = row[“ROADSEGMENTID”]
    plan_id = row[“TREATMENTPLANID”]
    year = row[ “YEAR”]
    cost_lookup[(road_id, plan_id)][year] =
row[ “TOTALYEARLYCOST”]
    pci_lookup[(road_id, planid)] = row[“avg_PCI”]
  return_cost_lookup, pci_lookup
```

The structure of cost_lookup will be a dictionary where:
The key is a tuple of (road_id, plan_id), which uniquely identifies a road segment and its associated treatment plan.
The value is another dictionary where the key is the year, and the value is the TOTALYEARLYCOST for that year.

The structure of pci_lookup will be a dictionary where:
This will store the average PCI values for each (road_id, plan_id) pair, so the key is (road_id, plan_id), and the value is the avg_PCI for that road segment and treatment plan.

The merge_lookups(lookups) function is designed to merge multiple lookup dictionaries from different chunks of data (which were processed in parallel)

```
def merg_lookups(lookups):
  # Merge lookups from multiple chunks
  merged_cost = defaultdict(dict)
  merged_pci = { }
  for cost, pci in lookups:
    for key, val in cost.items( ):
      merged_cost[key].update(val)
    merged_pci.update(pci)
  return merged_cost, merged_pci
```

A model initialization component 106 then defines decision variables xij to indicate whether a treatment plan j is selected for road segment I and initializes an optimization model 108 using a suitable computer-implemented solver. In an example embodiment, HIGHS is used (described in more detail below).

In an example embodiment, the code for decision variable defining may be as follows:

```
# Create valid combinations for decision variables
road_segments = data[“ROADSEGMENTID”].unique( )
valid_combinations = [
  (road, plan) for road in road_segments
  for plan in data[data[“ROADSEGMENTID] ==
road][“TREATMENTPLANID”].unique( )
```

In an example embodiment, the code for initializing the optimization model 108 may be as follows:

# Initialize model
model = ConcreteModel( )
# Define sets
model.road_segments = road_segments
model.years = sorted(data[“YEAR”].unique( ))
# Define variables
model.x = Var(valid_combinations, domain=Binary)

ConcreteModel( ): This initializes a Pyomo model. Pyomo is an open-source software package in Python used for formulating and solving mathematical optimization problems. A Pyomo model is a representation of an optimization problem that includes decision variables, objective functions, and constraints, which can be linear, nonlinear, or mixed-integer in nature. It provides a flexible and extensible framework for defining complex optimization models and supports a variety of solvers to find optimal solutions.
model.x: This defines a decision variable x in the model. The variable x will be used in the optimization process to represent whether a particular road segment is selected for a treatment plan in a given year.
The valid_combinations are the valid pairs of (road_segment, treatment_plan) combinations, which were created earlier in the code.

An objective definition component 110 then defines an objective, such as to maximize benefit, which in this case may be to minimize PCI or VOC. In an example embodiment, the code for defining an objective may be as follows:

```
#Objective: Minimize average PCI
model.objective = Objective(
  expr=quicksum(
    pci_lookup[(road_segment, treatment_plan)]
    model.x[(road_segment, treatment_plan)]
    for road_segment, treatment_plan in valid_combinations
  ),
  sense=1
)
```

The objective function here is to minimize the average PCI across all road segments and treatment plans by selecting which treatment plans to apply.

A constraint definition component 112 then defines a plurality of constraints, including, for example:
i. Unique Treatment Assignment: Ensure only one treatment is selected per road segment, and
ii. Total Budget Constraint: Ensure the aggregated cost across all years does not exceed the total budget, or
iii. Yearly Budget Constraints: Limit the yearly costs for selected treatments to predefined yearly budgets.
iv. Yearly Cost Category Budget Constraints: Limit the yearly costs for each cost category for selected treatments to predefined yearly budgets.

In an example embodiment, at the code level this may be implemented as follows:

### Constraint 1: One Treatment Plan Per Road Segment

The code defines a constraint ensuring that for every road segment in road_segments, exactly one treatment plan from the available options is chosen.
The constraint uses binary decision variables (model.x[(road_segment, plan)]), and the sum of these decision variables for each road segment must equal 1.

```
def one_treatment_per_road_rule(model, road_segment):
  return quicksum(
    model.x[(road_segment, plan)]
    for plan in data[data[“ROADSEGMENTEDID”] ==
road_segment][“TREATMENTPLANID”].unique( )
  ) == 1
model.one_treatment_constrait = Constraint(road_segments,
rule=one_treatment_per_road_rule)
```

### Constraint 2: Budget Constraints

```
      Yearly Budget Constraints
def budget_constraint_rule(model, year_idx):
  year = model.years[year_idx]
  return quicksum(
    cost_lookup[(road, plan)].get(year, 0) *
    model.x[(road, plan)]
    for road, plan in valid_combinations
    if year in cost_lookup[(road, plan)]
  ) <= budget[year_idx]
model.budget_constraints = Constraint(range(len(model.years)),
rule=budget_constraint_rule)
```

This defines a Python function budget_constraint_rule, which will serve as the rule for the budget constraint. The function specifies that the total cost of selected treatment plans for a given year must be less than or equal to the budget available for that year.
The decision variable model.x[(road, plan)] determines whether a treatment plan is applied to a road segment.
The cost of applying a treatment plan in a given year is accessed through cost_lookup, which stores the cost for each (road, plan) pair and year.
The total cost for each year is computed by summing the costs of the selected treatment plans for that year. The constraint enforces that the total cost should not exceed the corresponding budget for that year.

### Constraint 3: Total Budget Constraints

The function specifies that the total cost of selected treatment plans for all year must be less than or equal to the total budget available for all years.

```
def budget_constraint_rule(model):
  return quicksum(
    cost_lookup[(road, plan)].get(year, 0) * model.x[(road,
    plan)]
    for road, plan in valid_combinations
    for year in model.years # Iterate over all years
    if year in cost_lookup[(road, plan)]
  ) <= sum(budget)
model.budget_constraints = Constraint(rule=budget_constraint_
rule)
```

### Constraint 4: Yearly Cost Category Budget Constraints

This constraint ensures that the total cost for each year and each type of cost (e.g. maintenance or capital) does not exceed the specified budget.
For each cost type (e.g., maintenance, repair) and for each year (year_idx), the budget_constraint_rule function calculates the total cost using the decision variables and the cost lookup dictionary.

```
# Constraint 2: Budget constraints for each cost type
def budget_constraint_rule(model, cost_type, year_idx):
  year = model.years[year_idx]
  return quicksum(
    cost_lookup[(road, plan, cost_type)].get(year, 0) * model.x[(road, plan)]
    for road, plan in valid_combinations
    if year in cost_lookup[(road, plan, cost_type)]
  ) <= budget_dict[cost_type][year_idx]
model.budget_constraints = Constraing(cost-types, range(len(model.years)),
rule=budget_constraint_rule)
```

The optimization model 108 is then run. This may include solving the optimization problem using, for example, a HiGHS solver. HiGHS is open-source software to solve linear programming (LP), mixed-integer programming (MIP), and convex quadratic programming (QP) models.

In an example embodiment, the following code may be used to solve an optimization model using the HiGHS solver with customized solver parameters.
SolverFactory(“appsi_highs”): This creates a solver object that uses the HiGHS solver.
By enabling parallel processing and using all available CPU threads (cpu_counto), the solver can handle larger and more complex optimization problems faster. The HiGHS solver implements parallel processing by utilizing multiple CPU threads to handle larger and more complex optimization problems efficiently. It achieves this by distributing the computational workload across available processor cores, allowing simultaneous execution of different parts of the optimization algorithm. This approach reduces the time required to reach a solution by taking advantage of modern multi-core processors. The solver dynamically manages the allocation of tasks to threads, ensuring that the computational resources are used effectively. By parallelizing the linear algebra operations and other computationally intensive tasks, HiGHS can solve linear programming, mixed-integer programming, and quadratic programming models more quickly than single-threaded solvers. This capability is particularly beneficial for large-scale problems where the computational demands are significant. The parallel processing feature of HiGHS is designed to be robust, providing consistent performance improvements across a variety of problem types and sizes.
The solver will return results, including the optimal solution (if found), the objective value, and other details.

```
# Solve using HiGHS solver with optimized parameters
solver = SolverFactory(“appsi_highs”)
solver_options = {
    # ‘mip_rel_gap’: 0.01, # 1% optimality gap
  #  ‘time_limit’: 3600,  # 1-hour time limit
      ‘parallel’: “on”, # Enable parallel processing
      ‘threads’: cpu_count( ) # Use all available CPU threads
}
results = solver.solve(model, options=solver_options, tee=True)
# Check solver status
if results.solver.status != ‘ok’:
  raise ValueError(“Solver failed to find an optimal solution.”)
```

Output 114 of the optimization model includes treatment plans for each road segment, as well as associated costs and performance metrics. In an example embodiment, the post-processing component 116 may then perform postprocessing on the output 114. In the postprocessing, post-processing component 116 extracts the solution from the optimization model and organizes it into a pandas DataFrame for further analysis. For example:
if var.value==1, the condition checks whether the value of the decision variable (var.value) is equal to 1. If it is 1, that means the treatment plan for that road segment has been selected (the treatment plan is applied).
Once we confirm that the treatment plan is selected (i.e., var.value 1), the yearly costs for that treatment plan on the specified road segment are retrieved from the cost_lookup dictionary.
After collecting all the selected solutions (where var.value==1), a pandas DataFrame is created from the solution list.
At the end it will add a “total” row at the end of the DataFrame result_df, which summarizes the total costs for each year across all road segments and treatment plans.

In an example embodiment, the code for the post-processing component 116 may be as follows:

```
solution = [ ]
for(road_segment, treatment_plan), var in model.x.items( ):
  if var.value == 1:
    yearly_costs = cost_lookup[(road_segment, treatment_plan)]
    solution.append({
      “ROADSEGMENTID”: treatment_plan,
      “PCI”: pci_lookup[(road_segment, treatment_plan)],
      **yearly_costs
    })
# Create results DataFrame
result_df = pd.DataFrame(solution)
total_row = pd.concat([
    pd.Series( {
      “ROADSEGMENTID”: “Total”,
      “TREATMENTPLANID”: “”,
      “PCI”: “”
    }),
    result_df[model.years].sum( )
])
result_df = pd.concat([result_df, pd.DataFrame([total_row})},
ignore_index=True)
```

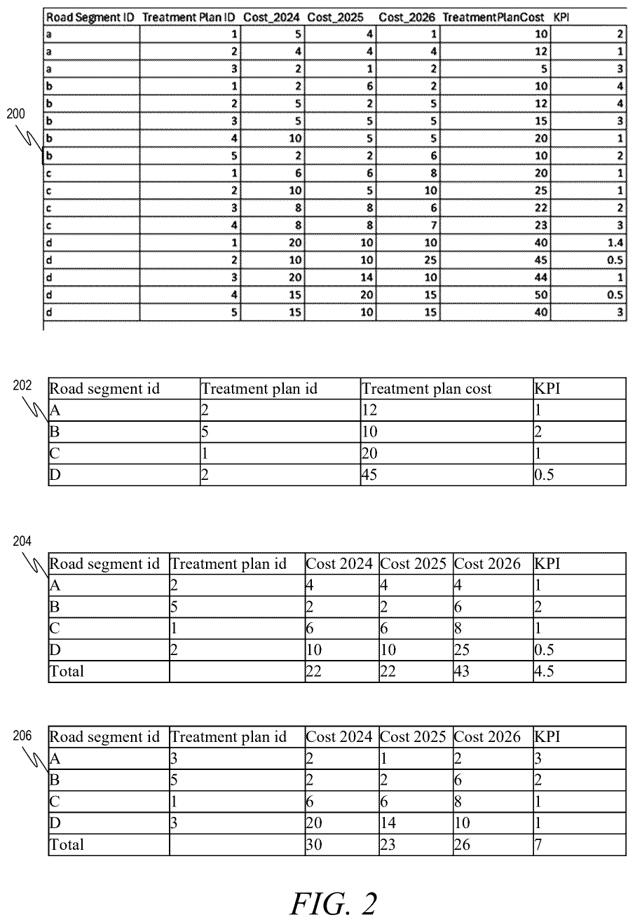

FIG. 2 is an example of optimizations performed on a sample dataset 200, in accordance with an example embodiment. Here, it may be assumed that there is a total budget constraint of 90 over the three years of treatment plan being optimized. There are several possible treatment plan combinations having a total cost under 90. Treatment plan combination 202 is selected as the one having the lowest KPI.

If, on the other hand, a yearly budget constraint of 300 was used rather than a total budget constraint of 90, then treatment plan combination 202 would not work because the total cost would exceed 30 in 2026, as can be seen by reference numeral 204, which is the same as treatment plan combination 202 but with the yearly cost breakdowns.

Instead, treatment plan combination 206 is selected, as it has the lowest KPI of the combinations that satisfy the yearly constraints.

In the above example, if one assumes a yearly budget to be 20, then the optimizer will result in infeasible solution, as min total budget=75, and a yearly budget of 20 will be a total of only 60. In an example embodiment, the system is able to automatically identify a minimum yearly cost needed for the optimizer results to be feasible.

The optimizer starts with the provided yearly budget value, in this case, 20. It then finds the minimum cost possible in the dataset, here, 75. Then the average yearly cost is calculated using the above value, here 75/3 as 3=number of years, here, 25

Thus:

```
Step 1:
      If Initial Budget(20) < Min Calculated Budget(25),
            Re-run the optimizer with yearly budget of 25,
            Budget = 25
            Status = status of optimizer(Feasible/ Infeasible)
            Move to Step 2
      else
            Budget = 20
            Status = status of optimizer(Infeasible)
Step 2:
      If Status = Feasible,
            Return min YearlyBudget = Budget
            Stop.
      Else
            Budget = 1.1* Budget
            Re-run the optimizer with budget = Budget
      Status = status of optimizer(Feasible/ Infeasible)
      Repeat Step 2
```

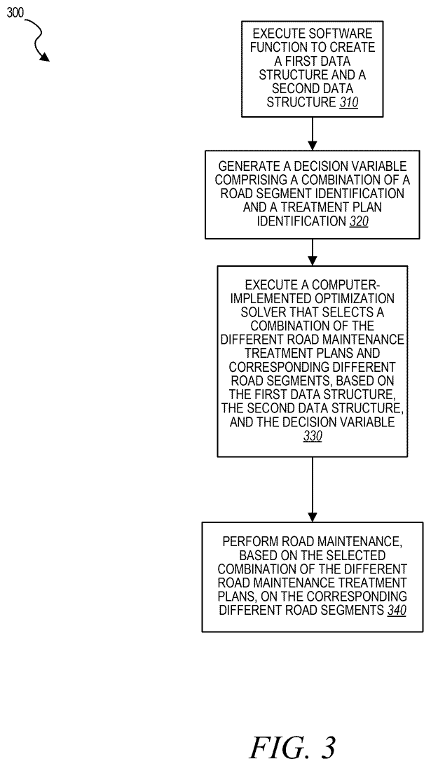

FIG. 3 is a flow diagram illustrating a method 300 of performing road maintenance, in accordance with an example embodiment.

At operation 310, a software function to create a first data structure and a second data structure is executed. The first data structure corresponding to costs of performing each of a plurality of different road maintenance treatment plans on each of a plurality of different road segments of a road, the second data structure corresponding to a first key performance indicator (KPI), based on input data comprising road maintenance treatment plan projections.

At operation 320, a decision variable comprising a combination of a road segment identification and a treatment plan identification is generated.

At operation 330, a computer-implemented optimization solver that selects a combination of the different road maintenance treatment plans and corresponding different road segments is executed, based on the first data structure, the second data structure, and the decision variable. The computer-implemented optimization solver identifies the combination based on minimizing the first KPI and based on one or more constraints.

At operation 340, road maintenance is performed, based on the selected combination of the different road maintenance treatment plans, on the corresponding different road segments.

In view of the disclosure above, various examples are set forth below. It should be noted that one or more features of an example, taken in isolation or combination, should be considered within the disclosure of this application.

Example 1 is a system comprising: at least one hardware processor; a non-transitory computer-readable medium storing instructions that, when executed by the at least one hardware processor, cause the at least one hardware processor to perform operations comprising: executing a software function to create a first data structure and a second data structure, the first data structure corresponding to costs of performing each of a plurality of different road maintenance treatment plans on each of a plurality of different road segments of a road, the second data structure corresponding to a first key performance indicator (KPI), based on input data comprising road maintenance treatment plan projections; generating a decision variable comprising a combination of a road segment identification and a treatment plan identification; and executing a computer-implemented optimization solver that selects a combination of the different road maintenance treatment plans and corresponding different road segments, based on the first data structure, the second data structure, and the decision variable, the computer-implemented optimization solver identifying the combination based on minimizing the first KPI and based on one or more constraints.

In Example 2, the subject matter of Example 1 comprises, wherein the executing the computer-implemented optimization solver comprises using parallel processing by parallelizing any linear algebra operations.

In Example 3, the subject matter of Examples 1-2 comprises, wherein the one or more constraints comprise that every road segment be assigned only one treatment plan.

In Example 4, the subject matter of Examples 1-3 comprises, wherein the one or more constraints comprise total budget.

In Example 5, the subject matter of Examples 1-4 comprises, wherein the one or more constraints comprise yearly budget.

In Example 6, the subject matter of Example 5 comprises, wherein the yearly budget is automatically calculated based on a total budget.

In Example 7, the subject matter of Examples 1-6 comprises, wherein the operations further comprise performing road maintenance, based on the selected combination of the different road maintenance treatment plans, on the corresponding different road segments.

Example 8 is a method comprising: executing a software function to create a first data structure and a second data structure, the first data structure corresponding to costs of performing each of a plurality of different road maintenance treatment plans on each of a plurality of different road segments of a road, the second data structure corresponding to a first key performance indicator (KPI), based on input data comprising road maintenance treatment plan projections; generating a decision variable comprising a combination of a road segment identification and a treatment plan identification; and executing a computer-implemented optimization solver that selects a combination of the different road maintenance treatment plans and corresponding different road segments, based on the first data structure, the second data structure, and the decision variable, the computer-implemented optimization solver identifying the combination based on minimizing the first KPI and based on one or more constraints.

In Example 9, the subject matter of Example 8 comprises, wherein the executing the computer-implemented optimization solver comprises using parallel processing by parallelizing any linear algebra operations.

In Example 10, the subject matter of Examples 8-9 comprises, wherein the one or more constraints comprise that every road segment be assigned only one treatment plan.

In Example 11, the subject matter of Examples 8-10 comprises, wherein the one or more constraints comprise total budget.

In Example 12, the subject matter of Examples 8-11 comprises, wherein the one or more constraints comprise yearly budget.

In Example 13, the subject matter of Example 12 comprises, wherein the yearly budget is automatically calculated based on a total budget.

In Example 14, the subject matter of Examples 8-13 comprises, performing road maintenance, based on the selected combination of the different road maintenance treatment plans, on the corresponding different road segments.

Example 15 is a non-transitory machine-readable medium storing instructions which, when executed by one or more processors, cause the one or more processors to perform operations comprising: executing a software function to create a first data structure and a second data structure, the first data structure corresponding to costs of performing each of a plurality of different road maintenance treatment plans on each of a plurality of different road segments of a road, the second data structure corresponding to a first key performance indicator (KPI), based on input data comprising road maintenance treatment plan projections; generating a decision variable comprising a combination of a road segment identification and a treatment plan identification; and executing a computer-implemented optimization solver that selects a combination of the different road maintenance treatment plans and corresponding different road segments, based on the first data structure, the second data structure, and the decision variable, the computer-implemented optimization solver identifying the combination based on minimizing the first KPI and based on one or more constraints.

In Example 16, the subject matter of Example 15 comprises, wherein the executing the computer-implemented optimization solver comprises using parallel processing by parallelizing any linear algebra operations.

In Example 17, the subject matter of Examples 15-16 comprises, wherein the one or more constraints comprise that every road segment be assigned only one treatment plan.

In Example 18, the subject matter of Examples 15-17 comprises, wherein the one or more constraints comprise total budget.

In Example 19, the subject matter of Examples 15-18 comprises, wherein the one or more constraints comprise yearly budget.

In Example 20, the subject matter of Example 19 comprises, wherein the yearly budget is automatically calculated based on a total budget.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

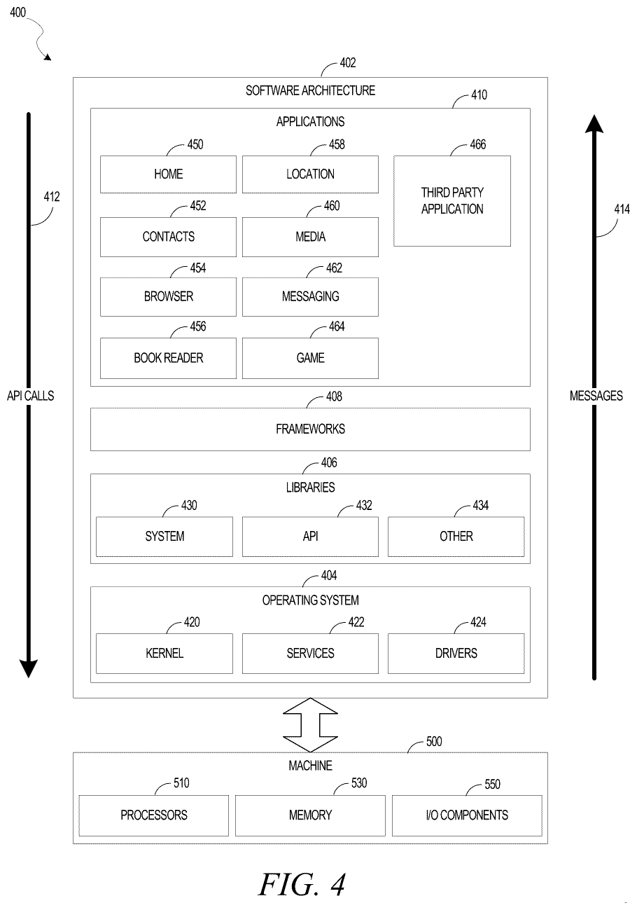

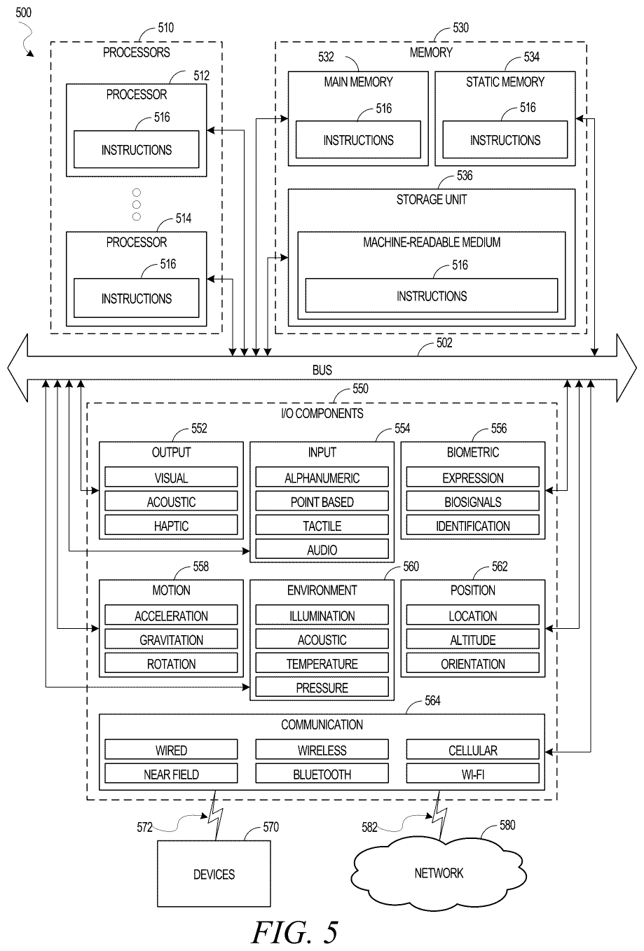

FIG. 4 is a block diagram 400 illustrating a software architecture 402, which can be installed on any one or more of the devices described above. FIG. 4 is merely a non-limiting example of a software architecture, and it will be appreciated that many other architectures can be implemented to facilitate the functionality described herein. In various examples, the software architecture 402 is implemented by hardware such as a machine 500 of FIG. 5 that comprises processors 510, memory 530, and input/output (I/O) components 550. In this example architecture, the software architecture 402 can be conceptualized as a stack of layers where each layer may provide a particular functionality. For example, the software architecture 402 comprises layers such as an operating system 404, libraries 406, frameworks 408, and applications 410. Operationally, the applications 410 invoke API calls 412 through the software stack and receive messages 414 in response to the API calls 412, consistent with some examples.

In various implementations, the operating system 404 manages hardware resources and provides common services. The operating system 404 comprises, for example, a kernel 420, services 422, and drivers 424. The kernel 420 acts as an abstraction layer between the hardware and the other software layers, consistent with some examples. For example, the kernel 420 provides memory management, processor management (e.g., scheduling), component management, networking, and security settings, among other functionalities. The services 422 can provide other common services for the other software layers. The drivers 424 are responsible for controlling or interfacing with the underlying hardware, according to some examples. For instance, the drivers 424 can comprise display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some examples, the libraries 406 provide a low-level common infrastructure utilized by the applications 410. The libraries 406 can comprise system libraries 430 (e.g., C standard library) that can provide functions such as memory allocation functions, string manipulation functions, mathematic functions, and the like. In addition, the libraries 406 can comprise API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics [PNG]), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 406 can also comprise a wide variety of other libraries 434 to provide many other APIs to the applications 410.

The frameworks 408 provide a high-level common infrastructure that can be utilized by the applications 410, according to some examples. For example, the frameworks 408 provide various GUI functions, high-level resource management, high-level location services, and so forth. The frameworks 408 can provide a broad spectrum of other APIs that can be utilized by the applications 410, some of which may be specific to a particular operating system 404 or platform.

In an example, the applications 410 comprise a home application 450, a contacts application 452, a browser application 454, a book reader application 456, a location application 458, a media application 460, a messaging application 462, a game application 464, and a broad assortment of other applications, such as a third-party application 466. According to some examples, the applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit (SDK) by an entity other than the vendor of the platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

FIG. 5 illustrates a diagrammatic representation of a machine 500 in the form of a computer system within which a set of instructions may be executed for causing the machine 500 to perform any one or more of the methodologies discussed herein, according to an example. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example, the instructions 516 may cause the machine 500 to execute the method 300 of FIG. 3, respectively. Additionally, or alternatively, the instructions 516 may implement FIGS. 1-3 and so forth. The instructions 516 transform the general, non-programmed machine 500 into a particular machine 500 programmed to carry out the described and illustrated functions in the manner described. In alternative examples, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specifies actions to be taken by the machine 500. Further, while only a single machine 500 is illustrated, the term “machine” shall also be taken to comprise a collection of machines 500 that individually or jointly execute the instructions 516 to perform any one or more of the methodologies discussed herein.

The machine 500 may comprise processors 510, memory 530, and I/O components 550, which may be configured to communicate with each other such as via a bus 502. In an example, the processors 510 (e.g., a central processing unit (CPU), a reduced instruction set computing (RISC) processor, a complex instruction set computing (CISC) processor, a graphics processing unit (GPU), a digital signal processor ((SP), an application-specific integrated circuit (ASIC), a radio-frequency integrated circuit (RFIC), another processor, or any suitable combination thereof) may comprise, for example, a processor 512 and a processor 514 that may execute the instructions 516. The term “processor” is intended to comprise multi-core processors that may comprise two or more independent processors (sometimes referred to as “cores”) that may execute instructions 516 contemporaneously. Although FIG. 5 shows multiple processors 510, the machine 500 may comprise a single processor 512 with a single core, a single processor 512 with multiple cores (e.g., a multi-core processor 512), multiple processors 512, 514 with a single core, multiple processors 512, 514 with multiple cores, or any combination thereof.

The memory 530 may comprise a main memory 532, a static memory 534, and a storage unit 536, each accessible to the processors 510 such as via the bus 502. The main memory 532, the static memory 534, and the storage unit 536 store the instructions 516 embodying any one or more of the methodologies or functions described herein. The instructions 516 may also reside, completely or partially, within the main memory 532, within the static memory 534, within the storage unit 536, within at least one of the processors 510 (e.g., within the processor's cache memory), or any suitable combination thereof, during execution thereof by the machine 500.

The I/O components 550 may comprise a wide variety of components to receive input, provide output, produce output, transmit information, exchange information, capture measurements, and so on. The specific I/O components 550 that are comprised in a particular machine will depend on the type of machine. For example, portable machines such as mobile phones will likely comprise a touch input device or other such input mechanisms, while a headless server machine will likely not comprise such a touch input device. It will be appreciated that the I/O components 550 may comprise many other components that are not shown in FIG. 5. The I/O components 550 are grouped according to functionality merely for simplifying the following discussion, and the grouping is in no way limiting. In various examples, the I/O components 550 may comprise output components 552 and input components 554. The output components 552 may comprise visual components (e.g., a display such as a plasma display panel (PDP), a light-emitting diode (LED) display, a liquid crystal display (LCD), a projector, or a cathode ray tube [CRT]), acoustic components (e.g., speakers), haptic components (e.g., a vibratory motor, resistance mechanisms), other signal generators, and so forth. The input components 554 may comprise alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 550 may comprise biometric components 556, motion components 558, environmental components 560, or position components 562, among a wide array of other components. For example, the biometric components 556 may comprise components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 558 may comprise acceleration sensor components (e.g., accelerometer), gravitation sensor components, rotation sensor components (e.g., gyroscope), and so forth. The environmental components 560 may comprise, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may comprise location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may comprise communication components 564 operable to couple the machine 500 to a network 580 or devices 570 via a coupling 582 and a coupling 572, respectively. For example, the communication components 564 may comprise a network interface component or another suitable device to interface with the network 580. In further examples, the communication components 564 may comprise wired communication components, wireless communication components, cellular communication components, near field communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., coupled via a USB).

Moreover, the communication components 564 may detect identifiers or comprise components operable to detect identifiers. For example, the communication components 564 may comprise radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

The various memories (e.g., 530, 532, 534, and/or memory of the processor(s) 510) and/or the storage unit 536 may store one or more sets of instructions 516 and data structures (e.g., software) embodying or utilized by any one or more of the methodologies or functions described herein. These instructions (e.g., the instructions 516), when executed by the processor(s) 510, cause various operations to implement the disclosed examples.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to comprise, but not be limited to, solid-state memories, and optical and magnetic media, comprising memory internal or external to processors. Specific examples of machine-storage media, computer-storage media, and/or device-storage media comprise non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 580 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 580 or a portion of the network 580 may comprise a wireless or cellular network, and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 516 may be transmitted or received over the network 580 using a transmission medium via a network interface device (e.g., a network interface component comprised in the communication components 564) and utilizing any one of a number of well-known transfer protocols (e.g., HTTP). Similarly, the instructions 516 may be transmitted or received using a transmission medium via the coupling 572 (e.g., a peer-to-peer coupling) to the devices 570. The terms “transmission medium” and “signal medium” mean the same thing and may be used interchangeably in this disclosure. The terms “transmission medium” and “signal medium” shall be taken to comprise any intangible medium that is capable of storing, encoding, or carrying the instructions 516 for execution by the machine 500, and comprise digital or analog communication signals or other intangible media to facilitate communication of such software. Hence, the terms “transmission medium” and “signal medium” shall be taken to comprise any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to comprise both machine-storage media and transmission media. Thus, the terms comprise both storage devices/media and carrier waves/modulated data signals.

What is claimed is:

1. A system comprising:
at least one hardware processor;
a non-transitory computer-readable medium storing instructions that, when executed by the at least one hardware processor, cause the at least one hardware processor to perform operations comprising:
executing a software function to create a first data structure and a second data structure, the first data structure corresponding to costs of performing each of a plurality of different road maintenance treatment plans on each of a plurality of different road segments of a road, the second data structure corresponding to a first key performance indicator (KPI), based on input data comprising road maintenance treatment plan projections;
generating a decision variable comprising a combination of a road segment identification and a treatment plan identification; and
executing a computer-implemented optimization solver that selects a combination of the different road maintenance treatment plans and corresponding different road segments, based on the first data structure, the second data structure, and the decision variable, the computer-implemented optimization solver identifying the combination based on minimizing the first KPI and based on one or more constraints.

2. The system of claim 1, wherein the executing the computer-implemented optimization solver comprises using parallel processing by parallelizing any linear algebra operations.

3. The system of claim 1, wherein the one or more constraints comprise that every road segment be assigned only one treatment plan.

4. The system of claim 1, wherein the one or more constraints comprise total budget.

5. The system of claim 1, wherein the one or more constraints comprise yearly budget.

6. The system of claim 5, wherein the yearly budget is automatically calculated based on a total budget.

7. The system of claim 1, wherein the operations further comprise performing road maintenance, based on the selected combination of the different road maintenance treatment plans, on the corresponding different road segments.

8. A method comprising:
executing a software function to create a first data structure and a second data structure, the first data structure corresponding to costs of performing each of a plurality of different road maintenance treatment plans on each of a plurality of different road segments of a road, the second data structure corresponding to a first key performance indicator (KPI), based on input data comprising road maintenance treatment plan projections;
generating a decision variable comprising a combination of a road segment identification and a treatment plan identification; and
executing a computer-implemented optimization solver that selects a combination of the different road maintenance treatment plans and corresponding different road segments, based on the first data structure, the second data structure, and the decision variable, the computer-implemented optimization solver identifying the combination based on minimizing the first KPI and based on one or more constraints.

9. The method of claim 8, wherein the executing the computer-implemented optimization solver comprises using parallel processing by parallelizing any linear algebra operations.

10. The method of claim 8, wherein the one or more constraints comprise that every road segment be assigned only one treatment plan.

11. The method of claim 8, wherein the one or more constraints comprise total budget.

12. The method of claim 8, wherein the one or more constraints comprise yearly budget.

13. The method of claim 12, wherein the yearly budget is automatically calculated based on a total budget.

14. The method of claim 8, further comprising performing road maintenance, based on the selected combination of the different road maintenance treatment plans, on the corresponding different road segments.

15. A non-transitory machine-readable medium storing instructions which, when executed by one or more processors, cause the one or more processors to perform operations comprising:
executing a software function to create a first data structure and a second data structure, the first data structure corresponding to costs of performing each of a plurality of different road maintenance treatment plans on each of a plurality of different road segments of a road, the second data structure corresponding to a first key performance indicator (KPI), based on input data comprising road maintenance treatment plan projections;
generating a decision variable comprising a combination of a road segment identification and a treatment plan identification; and
executing a computer-implemented optimization solver that selects a combination of the different road maintenance treatment plans and corresponding different road segments, based on the first data structure, the second data structure, and the decision variable, the computer-implemented optimization solver identifying the combination based on minimizing the first KPI and based on one or more constraints.

16. The non-transitory machine-readable medium of claim 15, wherein the executing the computer-implemented optimization solver comprises using parallel processing by parallelizing any linear algebra operations.

17. The non-transitory machine-readable medium of claim 15, wherein the one or more constraints comprise that every road segment be assigned only one treatment plan.

18. The non-transitory machine-readable medium of claim 15, wherein the one or more constraints comprise total budget.

19. The non-transitory machine-readable medium of claim 15, wherein the one or more constraints comprise yearly budget.

20. The non-transitory machine-readable medium of claim 19, wherein the yearly budget is automatically calculated based on a total budget.
